(19) United States
(12) Patent Application Publication
(10) Pub. No.: US 2023/0185591 A1
(43) Pub. Date: Jun. 15, 2023

(54) DATA ANALOG IDENTIFICATION METHOD

(71) Applicant: Petróleo Brasileiro S.A. - Petrobras, Rio de Janeiro (BR)

(72) Inventor: Marcelo Fagundes De Rezende, Rio de Janeiro (BR)

(21) Appl. No.: 18/081,483

(22) Filed: Dec. 14, 2022

(30) Foreign Application Priority Data
Dec. 15, 2021 (BR) 10 2021 025345 2

(51) Int. Cl. G06F 9/455

(52) U.S. Cl. CPC G06F 9/45508

(57) ABSTRACT

The present invention proposes a method for identifying data similarity, specifically applied to the execution of exploratory projects and geological characterization of reservoirs.

The invention evaluates different samples of a data population according to groupers defined by users and analyzes the data according to the population analyses, returning parametric indices that allow the comparison of groupers with definition of data analogy.

The invention provides greater productivity in identifying analogous occurrences by data and brings economic benefits by ensuring greater use of available data.

### FIELD OF INVENTION

The present invention is related to the area and application in the stages of data similarity identification for the execution of exploratory projects and geological characterization of reservoirs.

### DESCRIPTION OF THE STATE OF THE ART

In a scenario of large volume of data, the appropriate identification of analogous occurrences for geological evaluation and characterization is crucial for the development of reservoirs.

Traditionally, identification depends on arbitrary decisions by geologists or analyzes are performed with limited parameterization to identify data similarity and relevance.

Document US20200167693A1 deals with a method to determine the data similarity from a user pair. The method comprises the steps of: acquiring a to-be-detected user data pair, the to-be-detected user data pair including two sets of to-be-detected user data; performing feature extraction on each set of to-be-detected user data in the to-be-detected user data pair to obtain to-be-detected user features; and determining a similarity between users corresponding to the two sets of to-be-detected user data in the to-be-detected user data pair according to the to-be-detected user features and a pre-trained similarity classification model. The document relates to data similarity identification between data sets that have a direct and unique relationship with each other.

Document US20190056423A1 reveals an adjoint analysis method for the data, the method has the steps of: reducing a dimensionality of two-dimensional spatial data in original data of a target number to obtain one-dimensional spatial data of the target number; converting the one-dimensional spatial data of the target number and time data into a comparable trajectory queue of the target number; and calculating an adjoint similarity between the target number and one or more other numbers based on the trajectory queue of the target number. The document relates dimensionality reduction to identify internal similarity between a spatial data and a time variable.

Document US20180203917A1 discloses a processing device to group data items of a list of data items. The method can identify a set of groups based at least in part on similarity of data items of the list of data items; assigning data items of the list of data items to the one or more groups based at least in part on similarity of the data items assigned to each group of the one or more groups; and outputting a representation of the assignment of data items to one or more groups. The document lists the identification of specific signatures in a set of data from the signatures identified in any data.

The prior art presented has a specific logical arrangement for the applied problem, more complex mathematical composition, more complex statistical analysis rules, which include previous treatments, dimensionality reductions or training.

In view of the difficulties present in the state of the art mentioned above, and for solutions of identifying data analogues, it arises the need to develop a technology capable of performing effectively. The state of the art above mentioned does not have the unique characteristics that will be presented in detail below.

### OBJECT OF THE INVENTION

It is an object to increase productivity in identifying analogous occurrences by data and brings economic benefits by ensuring better use of available data.

### BRIEF DESCRIPTION OF THE INVENTION

The present invention proposes a method for identifying data similarity, specifically applied to the execution of exploratory projects and geological characterization of reservoirs.

The invention evaluates different samples of a data population according to groupers defined by users and analyzes the data according to the population analyses, returning parametric indices that allow the comparison of groupers with definition of data analogy.

The invention provides greater productivity in identifying analogous occurrences by data and brings economic benefits by ensuring greater use of available data.

### BRIEF DESCRIPTION OF DRAWINGS

The present invention will be described in more detail below, with reference to the attached figures which, in a schematic and not limiting of the inventive scope, represent examples of its realization. The drawings show:

FIG. 1 illustrates the flowchart provided for the method, starting with the criteria selection (1) and similarity degree definition intended by a user (2) and continued by automatic calculations to obtain the parametric indices (3), the indication of analogy between criteria (4) and indication of general analogy (5);

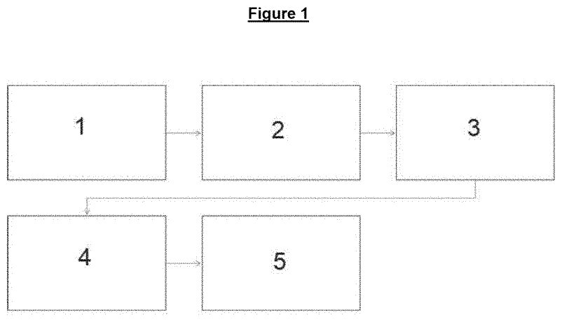

FIG. 2 illustrates the concept of the Knowledge Well Index (KWI), a parametric control index that evaluates the completeness of well information in a field based on the ratio between the number of wells that have information and the total number of wells and multiplied with each other. In the example data A occurs in 22 wells and data B occurs in 79 wells. The field has 139 wells in total. Therefore, data A is available at 0.16 of the wells in the field, while data B is available in 0.55 of the wells in the field, leading to a KWI of 0.09. Very low values indicate that the data chosen as criteria can lead to greater uncertainty in the analogy definition;

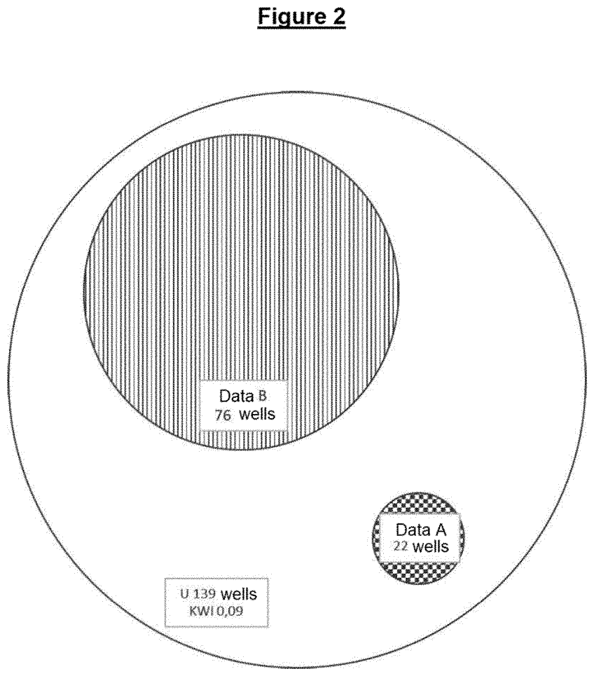

FIG. 3 illustrates the concept of Knowledge Quality index (KQI), a parametric index that assesses the quality of relationships between user-defined data criteria and the sampling universe of that data in the field. The KQI is the index that sustains the analogy parameterization between fields. Low numbers, close to zero, derived from a given conditioning criterion will harm the analogy, high values, close to 1 ensure better analogy. In the example, data A has better representation, but data B, as defined by the user, has low representation in the field, compared to the total number of records available for each data. Therefore, for data A we have a variation of 0.97 and for data B a variation of 0.08 leading to a KQI of 0.08;

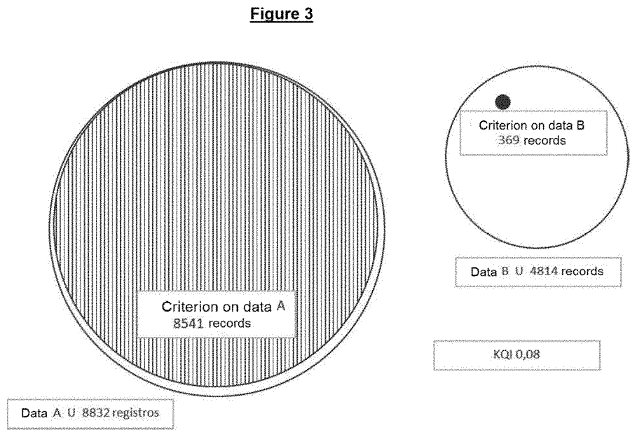

### DETAILED DESCRIPTION OF THE INVENTION

Below follows a detailed description of a preferred embodiment of the present invention, by way of example and in no way limiting. Nevertheless, it will be clear to a person skilled in the art, from the reading of this description, possible additional embodiments of the present invention further comprised by the essential and optional features below.

The invention allowed the identification of analogy in data when comparing the available data for an oil field, with other oil fields comparing the data populations indicated for each field as a criterion for analogy. It also allows the identification of data analogy of any grouper defined by a given user, with other similar groupers available in a given data set.

After calculating the KWI indexes (n wells with data/U of wells in the field) and KQI (n of records of the criterion/U of records in the field) that bring a view of data distribution and quality of this distribution in the fields, the Knowledge Analogy Index (KAI), which is obtained by z-score for each data criterion across different fields.

To determine Z in terms of KQI and the total number of records, the z-score equation (1) is used to compare populations with n>30, as follows. KAI=(KQI2-KQI1)/ROOT ((KQI2×((1−KQI2)/RT2))+(KQI1×((1−KQI1)/RT1))), where KQI1 and KQ12 refer to the Knowledge Quality Index for the data compared in fields 1 and 2, respectively, and RT 1 and 2 refer to the total number of data records in fields 1 and 2;

To determine the KAI, we started from the degree of similarity provided by the user to calculate the z values, obtained from a reference table for normal distribution. So, if the user defines the value of 99% for the desired analogues, the value obtained in the normal distribution table is 2.58. The following rules apply in sequence:

If Z calculated for the properties is greater than the Z estimated for the similarity degree provided by the user, then the area is similar and can be considered analogous, if it is less than or equal, then it will not be analogous, considering the null hypothesis.

For clarification purposes and considering KAI values for data A and B between fields 1 and 2, two values are calculated, respectively 16.161 and 16.531. These modules when compared with the estimated z-score of 12.581 for a similarity degree of 99% defined by the user, would indicate an analogy between these data for fields 1 and 2.

The invention solves the problem of searching for analogy between data from different fields, considering the nature of the data, its types, number of records through statistical population comparisons in order to provide user-controlled and comparable KWI, KQI and KAI reference indices between different data samples.

The invention evaluates different samples of a data population according to groupers defined by users and analyzes the data according to the comparison between the z-scores defined for the data population of fields and the intended similarity degree, with the indication of data analogy.

1- DATA ANALOG IDENTIFICATION METHOD, characterized by comprising the following steps:
a) Determining KWI and KQI distribution quality indices of data in oil fields;
b) Identifying analogy in data through population statistics methods, with definition of the KAI index;
c) Comparing oil field with other oil fields from available data.

2- METHOD, according to claim 1, characterized by determining Z in terms of KQI and the total number of records from the z-score equation (1) for comparison between populations with n>30.

3- METHOD, according to claim 1, characterized by determining KAI,
starting from the similarity degree provided by the user to calculate the z values using the z-scores determination table for normal distribution.

4- METHOD, according to claim 1, characterized in that If Z calculated for the properties is greater than the Z estimated for the similarity degree provided by the user, then the area is similar and can be considered analogous, if it is less than or equal, then it will not be analogous, considering the null hypothesis.
